(19) United States
(12) Patent Application Publication
(10) Pub. No.: US 2022/0381468 A1
(43) Pub. Date: Dec. 1, 2022

(54) APPARATUS FOR INTERPRETING, DISPLAYING AND TRANSMITTING STATUS AND ERROR OR FAULT CODES DISPLAYED ON AN ANOTHER DISPLAY

(71) Applicant: Sobie Systems Inc., Barrie (CA)

(72) Inventor: Sobhan ETEMADI, Barrie (CA)

(21) Appl. No.: 17/776,202

(22) PCT Filed: Nov. 11, 2020
(86) PCT No.: PCT/IB2020/060628

§ 371 Date: May 11, 2022

Related U.S. Application Data
(60) Provisional application No. 62/933,663, filed on Nov. 11, 2019.

(51) Int. Cl. F24F 11/56; G06F 3/147

(52) U.S. Cl. CPC F24F 11/56; G06F 3/147

(57) ABSTRACT

Described is an apparatus for wirelessly transmitting status or error codes displayed on a display, for example an LED or a seven-segment display on an HVAC control board. The apparatus has a modular construction to allow fitting a universal sensor to a plurality of displays of different configurations, through mounting plates configured for mounting to displays of different configurations but all able to mount to the universal sensor. In this manner, an HVAC status or error code can be collected and transmitted wirelessly.

### FIELD OF THE INVENTION

The invention relates to HVAC error code displays.

### BACKGROUND OF THE INVENTION

HVAC (Heating, ventilation, and air conditioning) systems are near ubiquitous. Nearly every home and building has a furnace, connected to and controlled by a thermostat of some kind. Often, the HVAC also have air conditioning and hot water tank or boiler systems.

HVAC systems often require maintenance and/or cleaning.

HVAC systems include controller boards and will sometimes comprise sensors coupled to the controller board.

HVAC system controller boards will typically have some kind of status display which is used to tell the user the status of the system and any error or faults that the HVAC may have experienced. On furnaces, these displays are generally located on the furnace control board or the gas valve. The status display may be one or a plurality of seven-segment displays, such as an LCD or LED panel, or it may simply be a single colored light, multi-colored light or a series of lights wherein their combinations define the HVAC status and any error codes. The status display may be static or may blink in different combinations or show codes intermittently. For example, an HVAC system may have a slowly flashing LED to show that the furnace is on but is not calling for heat, a rapidly flashing LED to indicate that the furnace is turned on and is calling for heat, or a continuous light that indicates a fault. There may be more than one LED, or intermittent flashing (flashing a number of times then pausing). Generally, when multiple faults are present, the error code is presented on an LED or seven-segment display followed by a pause and then the subsequent error is displayed; this pattern is repeated a number of times. Alternatively, there may be LEDs that indicate two-digit error codes such as 12 by the first digit determined by the number of short flashes and the second digit by the number of long flashes. In some HVAC, error codes can be defined by the blinking relationship between multiple LEDs, for example, if two LEDs are blinking simultaneously but slowly, then operation is normal, however, if one is flashing slowly while the other is off, then a flame has been sensed without the gas valve energized. An HVAC system may have a green LED and a red LED, with the green LED blinking when the HVAC system is in standby, a constant green LED light when the HVAC system is operational, and a blinking red LED when the HVAC system is at fault. Alternatively, an HVAC system may have a single digit seven-segment display which, for example, may display error code E followed by 2, 5, and 0 to denote error code E250 (open limit switch circuit). In some cases, the HVAC may have a two-digit seven-segment display which, for example, may display error code F4 to indicate an outdoor ambient temperature sensor error or F8 to denote an error with the exhaust temperature sensor. In some cases, a two-digit seven-segment display may display E4, alternating with 68, or E, alternating with 4 followed by 6 then 8, denoting error code E468 (sensor error). In some cases, the HVAC may have a three or four-digit seven-segment display that may show up to three-digit or four-digit alphanumeric codes.

Error codes are very useful diagnostics as a first step in determining what maintenance, repairs or further testing need to be done and are used as a way for technicians to classify the possible causes of an HVAC's problem(s). As a result, the first step in diagnosing an HVAC system problem is an understanding of the error code being displayed.

Hot water tanks and tankless water heaters generally have similar systems, though the error codes are typically not as complex or varied. Hot water tanks in general present their error codes through a sequence of blinks and pauses that are located on the external control module of the tank and tankless water heaters, in general, have both LEDs and LCD displays where alphanumeric codes like the furnace can be displayed. Similarly, air-conditioning systems are also now being equipped with seven-segment displays and LEDs on their control boards to classify status and error codes.

HVAC systems are typically serviced by qualified, specialized, repair personnel (also known as HVAC technicians or contractors).

Accordingly, when an HVAC user/owner has a problem, or suspects a problem, with their HVAC system, they will call a maintenance provider, who will send out repair personnel to diagnose and repair the HVAC system. Typically, the maintenance provider will ask the HVAC user/owner to read the error code displayed on the HVAC system, as a first step in the diagnosis. However, HVAC system control boards are typically not user-accessible, and/or the typical user of HVAC systems is uncomfortable removing a panel to access and read the error code. Even when accessible, the user may misread or mis-transmit the error code to the maintenance provider. In most cases nowadays, a view glass is located on the outer door of the furnace so that the error code can be visible, however, on many occasions and furnace brands, error codes occur intermittently and are not active when looking through the view glass. In some other instances, wiring inside the furnace compartment blocks the view glass and the error code display cannot be seen without removing the furnace door or sometimes secondary cover. As a result, maintenance providers will sometimes need to send out repair personnel twice—once to read the error code and diagnose the issue, a second time with the proper equipment or parts to address the specific diagnosed problem. It is generally not possible for a maintenance provider to have every piece of equipment and part in their truck, so it is typically standard practice for some HVAC maintenance calls to require two trips. Most furnace control boards maintain a history of the last few (generally five to ten) error codes, however, this method is not ideal as there is no way of identifying when and how frequently the stored faults occurred. Also, the technician will have to be physically present at the job site to cycle through the few codes available on the control board's memory.

There are a large number of manufacturers of HVAC systems, and as a result, a large number of configurations of control boards and a large number of error codes. A Daikin™ error code will likely be different from an LG™ error code, which may be different from the one on a Trane™, a Carrier™, Lennox™, Goodman™, Samsung™, Amana™, York™, Keeprite™, or other brand. In addition, there are widely different configurations of control boards, many with different readouts, in different locations. Though “smart” and IoT enabled HVAC systems, which are starting to come on line, promise “cloud” transmission of error codes, they are certainly not ubiquitous nor standardized. With furnace life expectancy often over 20 years, it may be decades before these types of systems become mainstream. Furthermore, manufacturers such as Lennox™, Carrier™, and Trane™, to name a few, have manufactured their own proprietary thermostats that may display the fault or error code of very limited, high-end models of their furnace lines. These proprietary thermostats do not work with other brands or furnace models and therefore are limited in their applications.

It would be desirable to have a system which is able to read the error codes off a wide variety of existing HVAC system control board for both new and retrofit applications and including both residential and commercial furnaces, air-conditioners, hot water tanks, boilers, tankless systems, or roof-top units, and transmit said error code with the suggested corrective actions to a user or maintenance provider in real-time. Such a system may be able to decrease operational expenses i.e. “multi-trip or repeat-visit” maintenance calls by forearming the maintenance provider with certainty with the knowledge of the error code on the HVAC system, allowing the maintenance personnel to come to the job with the right equipment and parts on the first visit. Furthermore, such as system would provide insights into intermittent faults that would otherwise go unnoticed. This information would change the current state of reactive monitoring of HVAC systems to a proactive monitoring method and help main the HVAC equipment lifetime as well as allow HVAC contractors to provide better services to their customers. The value of the error codes and diagnostic information that can be obtained from the HVAC or furnace control board through the LEDs, LCDs, and seven-segment displays can also provide furnace and air-conditioner status information through sequences of blinks and specific codes, for example, ‘0n’, ‘L0’, ‘H1’, ‘1dL’, amongst other codes, as well as performance indicators such as fan speed. This information may provide further proactive maintenance information to contractors so that smaller problems can be addressed before becoming costly break-downs. It would be desirable for such a system to be able to work with a large plurality of control board configurations, readout sizes, locations and configurations, and error codes.

### BRIEF DESCRIPTION OF THE FIGURES

FIG. 1 shows a camera module from an apparatus of the present invention.

FIG. 2 shows an LED reader from an apparatus of the present invention.

FIG. 2.1 shows the LED reader in an alternative configuration.

FIG. 3 shows, in somewhat exploded view, an apparatus of the present invention on an HVAC control board.

FIG. 4 shows an alternate configuration of the apparatus depicted of FIG. 1 and FIG. 3.

FIG. 5 shows an alternative embodiment of an apparatus of the present invention on an HVAC control board.

### SUMMARY OF THE INVENTION

According to one aspect of the present invention is provided an apparatus for displaying, transmitting and/or interpreting status and error codes displayed on an external display, comprising: (a1) a camera module, comprising a camera, a camera housing, and at least one camera housing mounting plate, said camera having a camera output; and/or (a2) an LED reader, comprising a light sensor and/or a color sensor, a light sensor and/or color sensor housing, and optionally at least one light or color sensor housing mounting plate, said light or color sensor having a light or color sensor output; and (b) an interface board, comprising a camera input and/or a light or color sensor input and/or an analog or digital voltage signal input, a microprocessor, a power input, and a wireless communication module; said camera housing mounting plate configured for permanent or semi-permanent mounting to the external display and having attaching means for removable attachment to said camera housing in a configuration such that, when the camera housing mounting plate is mounted to the external display and the camera housing is mounted to the camera housing mounting plate, the camera has a line of sight to the external display and is shrouded from external light; said light or color sensor mounting plate configured for permanent or semi-permanent mounting to the external display and having attaching means for removable attachment to said light or color sensor housing in a configuration such that, when the light or color sensor housing mounting plate is mounted to the external display and the light or color sensor housing is mounted to the light or color sensor mounting plate, the light or color sensor has a line of sight to the external display and is shrouded from external light; wherein said camera output is connected or connectable to the camera input on the interface board and said light sensor output is connected or connectable to the light sensor input on the interface board; and wherein the power input on the interface board is connectable to and capable of obtaining power from a control board of the external display; and wherein the microprocessor is capable of obtaining a signal from the camera and/or light and/or color sensor, processing said signal to a data form corresponding to the error code displayed on the external display, and transmitting said data form to an external processor through the wireless communication module.

In certain aspects, the apparatus further comprises a mirror display on said interface board, wherein said microprocessor is configured to control said mirror display to display the error code or a standardized error code based on the detected error code or signal.

In other aspects, the apparatus comprises: a signal capture board, mounting plate, and at least one spring-loaded contact pin.

According to one aspect of the present invention is provided an apparatus for displaying, transmitting and/or interpreting a status and/or an error code displayed on an external display, comprising: a mounting plate configured for permanent or semi-permanent mounting to the external display; an optical sensor module, comprising an optical sensor and an optical sensor housing, said optical sensor having a sensor output; said mounting plate having at least one attachment point for removable attachment to said optical sensor housing, the optical sensor housing having a corresponding at least one mounting plate attachment point; said mounting plate configured for attachment to the optical sensor housing through the at least one mounting plate attachment point such that the optical sensor has a line of sight to the external display and is shrouded from external light; wherein said sensor output is connected or connectable to a sensor input on an interface board; said interface board comprising the sensor input, a microprocessor, a power input, and a wireless communication module; said microprocessor configured to obtain a signal from the sensor input, and processing said signal to a data form corresponding to the status or error code displayed on the external display, and transmitting said data form to an external processor through the wireless communication module.

According to a further aspect of the present invention is provided a kit for use in displaying, transmitting and/or interpreting a status and/or an error code displayed on an external display, comprising: a plurality of mounting plates, each configured for permanent or semi-permanent mounting to an external display of different size, shape, or configuration; an optical sensor module, comprising an optical sensor and an optical sensor housing, said optical sensor having a sensor output; said plurality of mounting plates each having at least one attachment point for removable attachment to said optical sensor housing, the optical sensor housing having a corresponding at least one mounting plate attachment point; said mounting plate configured for attachment to the optical sensor housing through the at least one mounting plate attachment point such that the optical sensor has a line of sight to the external display and is shrouded from external light; wherein said sensor output is connected or connectable to a sensor input on an interface board; said interface board comprising the sensor input, a microprocessor, a power input, and a wireless communication module; said microprocessor configured to obtain a signal from the sensor input, and processing said signal to a data form corresponding to the status or error code displayed on the external display, and transmitting said data form to an external processor through the wireless communication module.

In certain embodiments, the external display is a 7 segment display, a through-hole LED, a surface-mount LED, or an LCD display.

In certain embodiments, the optical sensor is a camera, a light sensor, a photocell, a photodiode, a photoresistor, a phototransistor, or a color sensor.

In certain embodiments the apparatus or kit further comprises a power source connected to the power input.

In certain embodiments, the power input is connectable to and capable of obtaining power from a control board to which the external display is mounted.

In certain embodiments, the apparatus or kit further comprises a mirror display on said interface board, wherein said microprocessor is configured to control said mirror display to display the status or error code or a standardized status or error code corresponding to the status or error code.

In certain embodiments, each attachment point is a magnetic attachment point for attachment to a corresponding magnetic mounting plate attachment point.

In certain embodiments, the interface board or the optical sensor housing further comprise a signal amplifier inline and between the sensor and the microprocessor for amplification of the sensor output before reaching the microprocessor.

In certain embodiments, the external display is on or connected to a control board on an HVAC system or on an external control module attached to the HVAC system.

In certain embodiments, the external display is on or connected to a control board on a hot water heater, an air conditioner, a tankless water heater, or a boiler, or a control module of the hot water heater, air conditioner, tankless water heater, or boiler.

According to a further aspect of the present invention is provided an apparatus for displaying, transmitting and/or interpreting a status and/or an error code displayed on an external display, comprising: a mounting plate configured for permanent or semi-permanent mounting to the external display, said mounting plate having a plurality of contact points which, when the mounting plate is mounted to the external display, said contact points are in contact with and are in electrical continuity with a corresponding plurality of solder pads on the external display; said contact points connected or connectable to a signal input on an interface board; said interface board comprising the signal input, a microprocessor, a power input, and a wireless communication module; said microprocessor configured to obtain a signal from the signal input, and processing said signal to a data form corresponding to the status or error code displayed on the external display, and transmitting said data form to an external processor through the wireless communication module.

According to yet another aspect of the present invention is provided a kit for use in displaying, transmitting and/or interpreting a status and/or an error code displayed on an external display, comprising: a plurality of mounting plates, each configured for permanent or semi-permanent mounting to an external display of different size, shape, or configuration; each of said mounting plates having a plurality of contact points which, when the mounting plate is mounted to the external display, said contact points are in contact with and are in electrical continuity with a corresponding plurality of solder pads on the external display; said contact points connected or connectable to a signal input on an interface board; said interface board comprising the signal input, a microprocessor, a power input, and a wireless communication module; said microprocessor configured to obtain a signal from the signal input, and processing said signal to a data form corresponding to the status or error code displayed on the external display, and transmitting said data form to an external processor through the wireless communication module.

In certain embodiments, the external display is a 7 segment display, a through-hole LED, a surface-mount LED, or an LCD display.

In certain embodiments, the apparatus or kit further comprises a power source connected to the power input.

In certain embodiments, the power input is connectable to and capable of obtaining power from a control board to which the external display is mounted.

In certain embodiments, the apparatus or kit further comprises a mirror display on said interface board, wherein said microprocessor is configured to control said mirror display to display the status or error code or a standardized status or error code corresponding to the status or error code.

In certain embodiments, the interface board or the mounting plate further comprises a signal amplifier inline and between the contact points and the microprocessor for amplification of electrical signal before reaching the microprocessor.

In certain embodiments, the external display is on or connected to a control board on an HVAC system or on an external control module attached to the HVAC system.

In certain embodiments, the external display is on or connected to a control board on a hot water heater, an air conditioner, a tankless water heater, or a boiler, or a control module of the hot water heater, air conditioner, tankless water heater, or boiler.

In certain embodiments, the contact points are spring loaded contact pins.

According to yet a further aspect of the present invention is provided an apparatus for displaying, transmitting and/or interpreting a status and/or an error code displayed on an LCD, comprising: an optical sensor module, comprising an optical sensor and an optical sensor housing, said optical sensor having a sensor output; said optical sensor module configured to friction fit onto the LED such that the optical sensor has a line of sight to a signal emitted from the LED and is shrouded from external light; wherein said sensor output is connected or connectable to a sensor input on an interface board; said interface board comprising the sensor input, a microprocessor, a power input, and a wireless communication module; said microprocessor configured to obtain a signal from the sensor input, and processing said signal to a data form corresponding to the status or error code displayed on the LCD, and transmitting said data form to an external processor through the wireless communication module.

### DETAILED DESCRIPTION

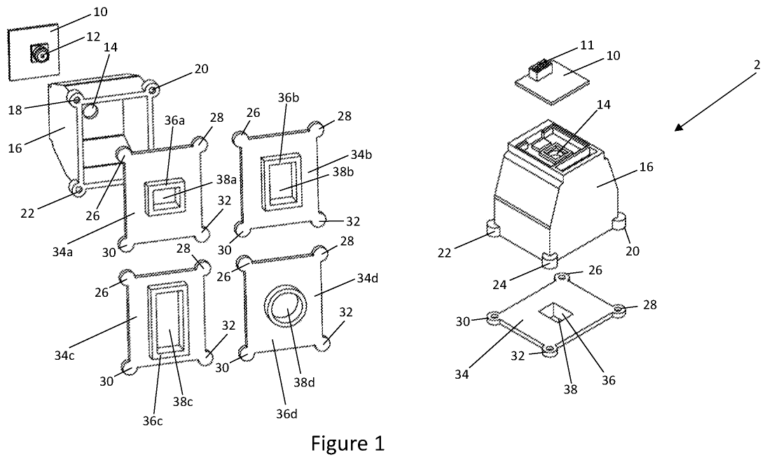

An exemplification of the apparatus of the present invention can be seen in FIGS. 1-5. FIG. 1 shows camera sensor apparatus 2. Camera circuit 10 holds camera 12 and is configured such that when mounted on camera housing 16 camera 12 fits through camera aperture 14. Camera circuit 10 also comprises output terminal 11 which is operationally connected to camera 12 and carries signal from camera 12 to the opposing side of camera circuit 10 from which the camera 12 is held. Camera housing 16 is made of a light resistant material and acts as a shroud for camera 12 as well as a physical mount for mounting plate 34. Camera housing 16 comprises attaching means for removably attaching it to mounting plate 34. As shown, attaching means comprises magnets 18, 20, 22, 24, which couple to complimentary magnets 26, 28, 30, 32 on mounting plate 34. Mounting plate 34 comprises frame 36 and readout aperture 38. Readout aperture 38 is configured such that it can be mounted onto an error code readout, such as a seven-segment display 40 or 40a found on the control board 42 of an HVAC unit. As shown, readout aperture 38 comprises frame 36 which is dimensionally configured to have a friction fit with the sides 41 of the seven-segment display 40. In this manner, the frame 36 is frictionally mounted to the seven-segment display 40 and camera housing 16 can thus be removably mounted to mounting plate 34 to surround the seven-segment display 40 to provide camera 12 with a clear field of view of seven-segment display 40 which is shrouded from external or incident light. In certain alternative configurations (not shown), frame 36 may be mounted to an area of control board 42 surrounding seven-segment display 40, for example, with adhesive. Similarly, in certain alternative configurations (not shown), camera housing 16 and mounting plate 34 may be removably attached through means other than magnets, for example with Velcro™, adhesive putty, a ‘quick-snap’, ‘slide-on’ or ‘lever-type’ mechanism, or other means known to the art. In certain alternative configurations (not shown), once camera housing 16 and mounting plate 34 are attached together, they are not removable from one another, for instance, where an adhesive is used to attach them together or where they are designed as a singular part.

In certain embodiments, and as illustrated in FIG. 1, mounting plate 34 can be provided in several different configurations (shown as 34a, 34b, 34c, 34d), each with readout apertures 38 (and corresponding frames 36) of different sizes (shown as 36a-d and 38a-d, respectively). This enables the same “universal” camera housing 16 to be mounted to different HVAC units, with control boards 42 having displays such as seven-segment display 40 of different shapes and configurations as well as LEDs 80, 82. Thus the invention provides a very inexpensive and user-friendly way of fitting camera housing 16 to a wide variety of different HVAC units, with varying control boards and error signal outputs, by utilizing a mounting plate 34 specifically designed and configured for the particular HVAC unit, without the need for modification or customization of the more expensive camera housing 16. In addition, as new HVAC units are designed, it becomes very easy to adapt existing sensor inventory to be used on the new HVAC unit control board, simply by manufacturing a new mounting plate 34 sized and configured to the new HVAC control board.

The apparatus also comprises interface board 44 which is connected with a wire (not shown) to camera output terminal 11 through interface terminal 45. Interface board 44 is connected to the furnace control board 42 through 24 vAC output port 46 and ground port 48, which are connected to corresponding port inputs 50, 52 on the interface board 44. Having interface board 44 separate from camera housing 16, connected by wire, allows for flexible configuration so that interface board 44 can receive power in this manner from the HVAC control board 42, and camera housing 16 can be properly surrounding seven-segment display 40, in a variety of different control board configurations. Thus this two part configuration (having the interface board 44 and the camera 12 connected by wire instead of being one part), while optional, is preferable, since it facilitates the use of the apparatus of the present invention on a variety of HVAC units, without needing additional design or configuration modifications based on the distance between the error display panel (for example the seven-segment display 40), the 24 vAC output port 46, and the interface board 44.

Thus, interface board 44 utilizes power from HVAC control board 42 to power camera 12. In an alternative configuration (not shown) the interface board 44 may be battery operated and not require the power input from the HVAC control board 42.

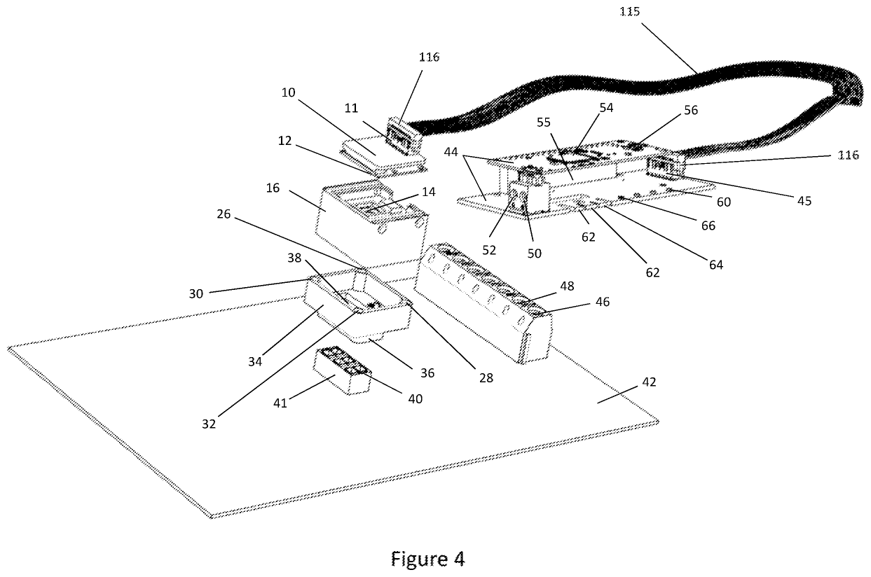

Interface board 44 also comprises microprocessor 54 for controlling camera 12 and (optionally) for processing signal obtained from camera 12. Interface board 44 also comprises a wireless communication module 56 which may for example be a WiFi, LTE, LoRa, and/or BLE wireless communication chip, used to transmit processed image data from the microprocessor 54 to an external computer, for example through the cloud to an HVAC maintenance provider. Optionally and as shown, camera board also comprises an external antenna connector 58 for connection of an external WiFi, LTE, LoRa, and/or BLE antenna (not shown). In other embodiments, the interface board 44 may have an integrated antenna for the same purpose. In an alternate configuration, as shown in FIG. 4, the interface board 44 may be comprised of an assembly of more than one circuit board connected to one another through board-to-board connector 55. Camera board may have other electronic components, such as a rechargeable back-up battery, a read only memory, a random access memory, resistors, capacitors, LEDS, connectors, and the like.

It is noted that once the apparatus is installed on an HVAC control board, it becomes difficult or impossible to manually read the error codes from seven-segment display 40 since it is obstructed by camera housing 16. Therefore, to avoid having to remove the apparatus every time it is desired to manually read the error codes, interface board 44 optionally (and as shown) comprises one or more of LEDs 60, LED signal transmitter connectors 62, or its own mirroring seven-segment display (not shown). In the case of the mirroring seven-segment display (not shown), the display is configured to mirror the error code displayed on seven-segment display 40, based on image capture by camera 12 and signal processing at microprocessor 54. Alternatively, mirroring seven-segment display (not shown) may provide a “universal” error code, in effect translating the error code shown on seven-segment display 40 to a code unique to the apparatus. In this manner, a maintenance professional would not need to know the error codes of all the different HVAC manufacturers, but only need to know the error codes of the apparatus. Alternatively, the processing of the universal error code can be done on the cloud and transmitted to an HVAC contractor's mobile phone or web dashboard through an App or website. In the case of LEDs 60, these may similarly mirror the error code on the seven-segment display 40. In the case of LED signal transmitter connectors 62, these can be connected by wire to a remote display, either affixed to the outside of the HVAC unit or in some other accessible and convenient location, for a replication of the error code or the translated error code as previously described.

As would be readily apparent, the error code display on the HVAC control board may not be a seven-segment display, but may be some other type of display, such as an LCD panel, or a simple LED. Mounting plate 34 may be configured for affixing to any such display, with similar use and effect. Likewise, the apparatus as shown could be used to monitor and/or mirror any display such as an error display on a hot water tank, tankless water heater, air-conditioner, boiler, or even an alarm system.

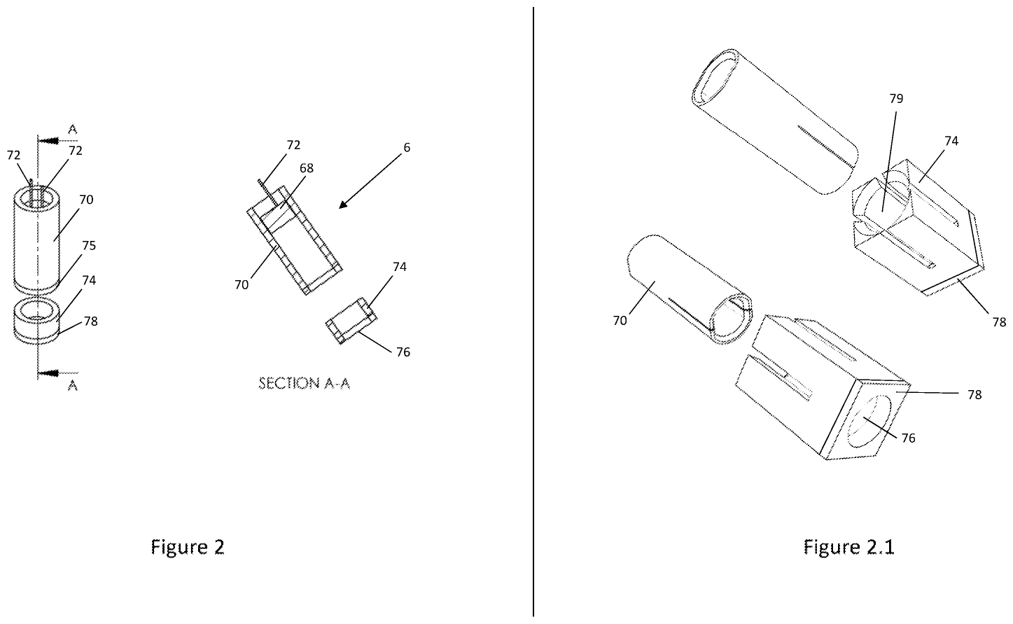

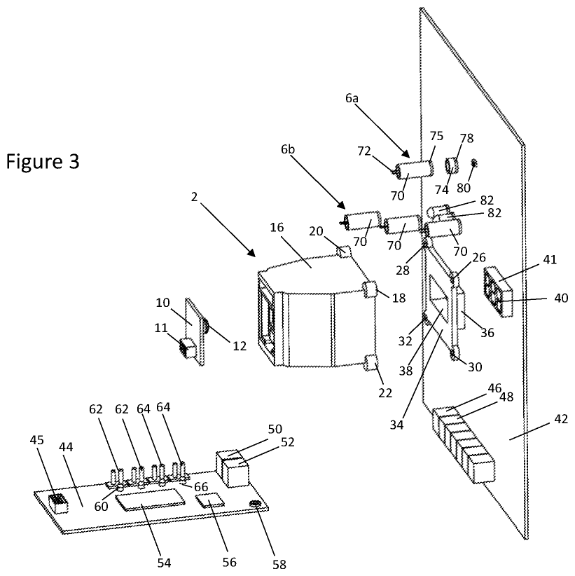

A further embodiment of the invention is shown in FIG. 2, which is an adaptation of the apparatus for use on an LED. In certain cases, HVAC systems use a 5 mm LED, or a circuit-board mounted mini-LED, instead of a seven-segment display for the display of error codes. For example, in some cases, a camera may not be necessary—an HVAC system will use a series of LEDs of various colors and blinking patterns to display error codes and sometimes may use LEDs that are capable of generating multiple colors. In such cases, the LED sensor apparatus of FIG. 2 can be used instead of the camera sensor apparatus of FIG. 1. In certain cases, as depicted for example in FIG. 3, an HVAC system may utilize both LEDs and seven-segment displays to display error codes; in such cases it would be practical to utilize both the camera sensor apparatus of FIG. 1 and the LED sensor apparatus of FIG. 2. It is noted that an LED sensor apparatus of FIG. 2 will be needed for each LED and a camera sensor apparatus of FIG. 1 will be needed for each seven-segment display from which it is desired to read error codes.

As would be appreciated, in order to “read” an LED, a camera is not necessary, and is unnecessarily expensive. Accordingly, for LED sensor apparatus of FIG. 2, a simple, cheap light intensity sensor (photocell, photoresistor, phototransistor, photodiode, color sensor, or similar sensors) may be used instead of a camera.

Thus, LED sensor apparatus comprises a light or color sensor 68 housed within a light sensor housing 70 and having output leads 72. For color sensors the number of output leads 72 will increase depending on the number of colors the sensor is capable of detecting. Light sensor housing 70 is removably coupled to light sensor mounting plate 74, for example, with magnet 75, to provide a light path between light sensor 68 and light sensor aperture 76. Light sensor mounting plate 74 in turn comprises adhesive 78 for attaching to the HVAC control board 42 in a manner such that it surrounds a control board LED 80. An alternate configuration of light sensor mounting plate 74 is shown in FIG. 2.1 where light sensor housing 70 is removably coupled to light sensor mounting plate 74 by press-fit into light sensor mounting cavity 79.

For larger LEDs, such as 5 mm LEDs 82, a light sensor mounting plate may not be necessary, and light sensor housing 70 may be friction fit overtop of the 5 mm LED 82, as shown in FIG. 3. In this embodiment, a magnet may not be necessary, and the connection may rely simply on a friction fit; alternatively, adhesive may be used to affix the light sensor housing 70 to the HVAC control board 42.

Light sensor 68 may be connected to interface board 44 by connecting output leads 72 to LED sensor connectors 64. Corresponding mirroring LEDs 66 may be used to mirror the light output of HVAC LEDs 80, 82, as described above, since HVAC LEDs 80, 82 cannot be seen by a user due to their obstruction by light sensor housing 70. Microprocessor 54 can control and process light signal from light sensor 68 much as previously described for camera 12, with information from error codes “read” in this manner transmitted to a user via wireless communication module 56 and/or by mirroring error code readouts either on the interface board 44 or remote mirroring error code readouts connected to the interface board 44 through LED signal transmitter connections 62 as previously described.

In an alternative embodiment, and to eliminate the need for any image or light processing to capture error codes, it may be advantageous to read the voltage signals directly from the leads of the seven-segment display 40, 40a or LEDs 80, 82 mounted on the control board 42.

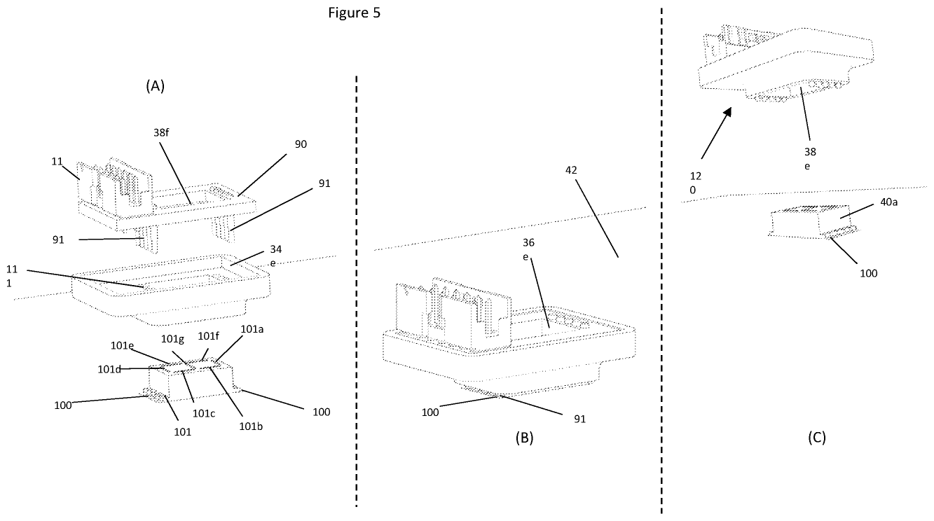

In such a configuration, exemplified in FIG. 5, the mounting plate 34 may be replaced with active mounting plate 34e, having spring-loaded contact pins 91. The spring-loaded contact pins 91, which are connected to signal capture board 90, pass through signal guide holes 111 and connect to solder pads 100 on the HVAC control board 42 by press-fitting the active mounting plate 34e around the seven-segment display 40a through frame 36e. Typically, the number of spring-loaded contact pins 91 are equal to and correspond to the solder pads 100 on the seven-segment display 40, 40a or LEDS 80, 82.

Each solder pad 100 is connected to the control board 42 via the respective seven-segment element lead 101. Each seven-segment element lead 101 drives the seven-segment element 101 a-g. Depending on the type of seven-segment such as common anode or common cathode, when a voltage is applied or removed from the seven-segment element lead 101 the respective seven-segment element 101 a-g will either turn on or off.

Spring-loaded contact pins 91 are in contact with solder pads 100 and “read” the voltage signals from the control board 42 through signal capture board 90 and transmit them to interface board 44 via output terminal 11. Output terminal 11 is connected to interface terminal 45 using ribbon cable 115 and ribbon cable connectors 116. The signals can then be either locally amplified and processed with the onboard microprocessor 54 or they can be transmitted to the cloud using the wireless communication module 56. Based on whichever spring-loaded pin 91 is providing the voltages, the alphanumeric code of the seven-segment display 40, 40a can be determined.

Readout aperture 38e-f make it possible for a user or technician to view the codes on the seven-segment display 40, 40a without having the remove the signal adapter apparatus 120. Alternatively, a “mirror” display can be provided on an interface board (not shown) as previously described for other embodiments.

The frame 36e may be made in different sizes and configurations, around correspondingly shaped seven-segment displays and can also be configured to read the voltage from either directly the component pins or the solders pads of an LED connected to a control board 42. If a component on the control board 42 is too small to hold the signal sensor apparatus 120 in place, adhesive such as double-sided tape (not shown) can be used to connect the signal sensor apparatus 120 to the control board 42 while lining up the spring-loaded contact pins 91 with the appropriate solder pads 100—this could be the case where the pins of the seven-segment display 40 or LED 82 may not be readily accessible from the front side of the control board 42 (i.e. the signal sensor apparatus 120 can simply be connected to the respective component from the opposite side of the control board 42).

### PARTS LIST

Camera sensor apparatus 2
LED sensor apparatus 6
Camera circuit 10
Output terminal 11
Camera 12
Camera aperture 14
Camera housing 16
Magnets 18, 20, 22, 24, 26, 28, 30, 32
Mounting plate 34
Frame 36
Readout aperture 38
Seven-segment display 40
Seven-segment sides 41
Control board 42
Interface board 44
Interface terminal 45
24 vAC output port 46
Ground port 48
24 vAC input port 50
Ground input port 52
Microprocessor 54
Board-to-board connector 55
Wireless communication module 56
External antenna connector 58
LEDs 60
LED Signal transmitter connectors 62
LED Sensor Connectors 64
Mirror LEDs 66
Light sensor 68
Light sensor housing 70
Light sensor output leads 72
Light sensor mounting plate 74
Magnet 75
Light sensor aperture 76
Adhesive 78
Light sensor mounting cavity 79
Control board LED 80
5 mm LED 82
Signal capture board 90
Spring-loaded contact pins 91
Solder pads 100
Seven-segment element lead 101
Seven-segment element 101a-g
Signal guide holes 111
Ribbon cable 115
Ribbon cable connector 116
Signal sensor apparatus 120

1. A kit for use in displaying, transmitting and/or interpreting a status and/or an error code displayed on an external display, comprising:
at least one mounting plate configured for permanent or semi-permanent mounting to the external display;
an optical sensor module, comprising an optical sensor and an optical sensor housing, said optical sensor having a sensor output;
said mounting plate having at least one attachment point for removable attachment to said optical sensor housing, the optical sensor housing having a corresponding at least one mounting plate attachment point;
said mounting plate configured for attachment to the optical sensor housing through the at least one mounting plate attachment point such that the optical sensor has a line of sight to the external display and is shrouded from external light;
wherein said sensor output is connected or connectable to a sensor input on an interface board;
said interface board comprising the sensor input, a microprocessor, a power input, and a wireless communication module;
said microprocessor configured to obtain a signal from the sensor input, and processing said signal to a data form corresponding to the status or error code displayed on the external display, and transmitting said data form to an external processor through the wireless communication module.

2. The kit of claim 1, wherein the at least one mounting plate comprises:
a plurality of mounting plates, each configured for permanent or semi-permanent mounting to an external display of different size, shape, or configuration.

3. The kit of claim 1 wherein the external display is a 7 segment display, a through-hole LED, a surface-mount LED, or an LCD display.

4. The kit of claim 1 wherein the optical sensor is a camera, a light sensor, a photocell, a photodiode, a photoresistor, a phototransistor, or a color sensor.

5. The kit of claim 1 further comprising a power source connected to the power input.

6. The kit of claim 1 wherein the power input is connectable to and capable of obtaining power from a control board to which the external display is mounted.

7. The kit of claim 1, further comprising a mirror display on said interface board, wherein said microprocessor is configured to control said mirror display to display the status or error code or a standardized status or error code corresponding to the status or error code.

8. The kit of claim 1 wherein each attachment point is a magnetic attachment point for attachment to a corresponding magnetic mounting plate attachment point.

9. The kit of claim 1 wherein the interface board or the optical sensor housing further comprise a signal amplifier inline and between the sensor and the microprocessor for amplification of the sensor output before reaching the microprocessor.

10. The kit of claim 1 wherein the external display is on or connected to a control board on an HVAC system or on an external control module attached to the HVAC system.

11. The kit of claim 1 wherein the external display is on or connected to a control board on a hot water heater, an air conditioner, a tankless water heater, or a boiler, or a control module of the hot water heater, air conditioner, tankless water heater, or boiler.

12. A kit for displaying, transmitting and/or interpreting a status and/or an error code displayed on an external display, comprising:
at least one mounting plate configured for permanent or semi-permanent mounting to the external display, said mounting plate having a plurality of contact points which, when the mounting plate is mounted to the external display, said contact points are in contact with and are in electrical continuity with a corresponding plurality of solder pads on the external display;
said contact points connected or connectable to a signal input on an interface board;
said interface board comprising the signal input, a microprocessor, a power input, and a wireless communication module;
said microprocessor configured to obtain a signal from the signal input, and processing said signal to a data form corresponding to the status or error code displayed on the external display, and transmitting said data form to an external processor through the wireless communication module.

13. The kit of claim 12 wherein the at least one mounting plate is a plurality of mounting plates, each configured for permanent or semi-permanent mounting to an external display of different size, shape, or configuration.

14. The kit of claim 12 wherein the external display is a 7 segment display, a through-hole LED, a surface-mount LED, or an LCD display.

15. The kit of claim 12 further comprising a power source connected to the power input.

16. The kit of claim 12 wherein the power input is connectable to and capable of obtaining power from a control board to which the external display is mounted.

17. The kit of claim 12, further comprising a mirror display on said interface board, wherein said microprocessor is configured to control said mirror display to display the status or error code or a standardized status or error code corresponding to the status or error code.

18. The kit of claim 12 wherein the interface board or the mounting plate further comprises a signal amplifier inline and between the contact points and the microprocessor for amplification of electrical signal before reaching the microprocessor.

19. The kit of claim 12 wherein the external display is on or connected to a control board on an HVAC system or on an external control module attached to the HVAC system.

20. The kit of claim 12 wherein the external display is on or connected to a control board on a hot water heater, an air conditioner, a tankless water heater, or a boiler, or a control module of the hot water heater, air conditioner, tankless water heater, or boiler.

21. The kit of claim 12 wherein the contact points are spring loaded contact pins.

22. An apparatus for displaying, transmitting and/or interpreting a status and/or an error code displayed on an LCD, comprising:
an optical sensor module, comprising an optical sensor and an optical sensor housing, said optical sensor having a sensor output; said optical sensor module configured to friction fit onto the LED such that the optical sensor has a line of sight to a signal emitted from the LED and is shrouded from external light;
wherein said sensor output is connected or connectable to a sensor input on an interface board;
said interface board comprising the sensor input, a microprocessor, a power input, and a wireless communication module;
said microprocessor configured to obtain a signal from the sensor input, and processing said signal to a data form corresponding to the status or error code displayed on the LCD, and transmitting said data form to an external processor through the wireless communication module.
